(19) United States
(12) Patent Application Publication
(10) Pub. No.: US 2003/0143368 A1
(43) Pub. Date: Jul. 31, 2003

(54) Textile skin cleaning device

(76) Inventors: Gregor Kohlruss, Borken (DE); Hubert Wiesner, Sudlohn (DE); Oliver Griebe, Rhede (DE)

Correspondence Address: WILLIAM COLLARD, COLLARD & ROE, P.C., 1077 NORTHERN BOULEVARD, ROSLYN, NY, 11576, US

(21) Appl. No.: 10/220,579

(22) PCT Filed: Mar. 2, 2001
(86) PCT No.: PCT/EP01/02393

(30) Foreign Application Priority Data
Mar. 3, 2000 (DE) 100-10-162.3

(51) Int. Cl. D04H 3/00; B32B 3/02; D05C 17/00

(52) U.S. Cl. 428/92; 442/340; 442/351; 442/352; 442/414

(57) ABSTRACT

The invention relates to a skin cleaning device that consists of textile structure and that is at least partially provided with lipophilic fibers. Due to the provision of lipophilic fibers the inventive skin cleaning device is especially useful for cleaning oily and mixed skin since the fibers impart to the device a higher fat absorption capacity as compared to conventional skin cleaning textiles. The inventive skin cleaning device is further very environmentally friendly as it allows to widely or completely avoid the use of fat-dissolving cleaning agents.

The invention concerns a skin cleansing device made from a textile body, which is specially oriented to the cleansing needs of oily skin and mixed-type skin.

For the cleansing of oily, dirty skin, it is customary to use disposable articles made from nonwoven, formed fabric, which are impregnated with skin cleansing or skin care active substances or are offered for sale already so impregnated. The skin cleansing active substances, generally skin cleansing lotion or skin cleansing water, serve to dissolve the dirt particles present on the skin surface, peeled-off skin flakes and sebum, which are then mechanically carried away from the skin by means of the disposable nonwoven articles. Also, the use of conventional textile washcloths are state of the art. Since the cleansing of the skin on the basis of water and these conventional washcloths is not sufficient for the care of oily skin, skin cleansing detergents are ordinarily used in addition to bind the sebum and dirt particles and produce a cleansing of the skin in combination with the mechanical rubbing action of the textile washcloth.

Since it is therefore essential to employ disposable or expendable articles in the known methods of skin cleansing in the state of the art, the cleansing of especially problematical, oily skin involves a high cost outlay. Furthermore, the breakdown of the usually synthetic skin cleansing detergents, and also at least some of the ingredients of the skin cleansing lotions and waters, is not without problems, so that their use is a burden on the water system and thus the environment.

Furthermore, the detergents, lotions or waters used for this have potential allergens, so that allergies and allergic reactions can occur in those who are sensitive in this regard.

A further group of problems is the frequent overuse of detergents, lotions and skin cleansing waters, such that any given combination of these cleansing substances is often used excessively in the effort to obtain clean and normal skin. Thus, the skin is often first cleaned with water and a skin cleansing detergent and then cleaned again with cleansing water and face lotion. This constitutes a great burden on the skin, so that the result is disruption of the pH equilibrium of the skin and mechanical overloading, making the skin vulnerable to environmental factors and invading microorganisms. The result is often not an improved, but instead a worsened skin situation. Especially because the excessive removal of oil results in intensified production of sebum by the sebaceous glands of the skin, in the worst case there may result severe disturbances of the skin, such as acne.

In view of the problems accompanying the use of detergents, lotions or skin cleansing waters and in view of the fact that the conventional textile washing articles in the state of the art such as washcloths are not sufficient to adequately cleanse oily skin without the use of additional skin cleansing expendable materials, the problem of the invention is to provide a textile cleansing device for the skin, which in combination with water is sufficient to cleanse oily skin as much as possible without the use of additional cleansing expendable materials.

This problem is solved according to the invention by a skin cleansing device made from a textile body, which contains at least partially facing of lipophilic fibers. The lipophilia of the fibers present in the device itself produces a greater cleansing effect than conventional textile structures, so that the use of additional cleansing expendable materials can be largely eliminated.

Since it is possible to largely eliminate the use of skin cleansing expendable materials when using the skin cleansing device of the invention and the device itself can be washed out and reused many times, the skin cleansing device of the invention has considerable cost benefits compared to the state of the art. Furthermore, its use helps protect the environment. Moreover, it avoids skin irritations mediated by skin cleansing chemicals, since the acid protective mantle of the skin remains intact and furthermore the risk of allergic reactions is minimized.

Advisedly, the lipophilic fibers are at least partially configured as microfibers, which are suitable to provide an especially large cleansing surface by virtue of their small diameter and thereby intensify the cleansing action.

The skin cleansing device of the invention is preferably outfitted at least in part with a fiber facing having density of 30,000 per cm² or more, which applies preferably to the density of the microfibers. Thanks to the high density of the microfiber facing, the textile skin cleansing device of the invention furnishes an especially large active surface, which gives it an especially good capacity to absorb oil, boosted by the lipophilic nature of the microfibers.

In a preferred embodiment, the textile body of the skin cleansing device according to the invention is at least partly configured as a pile fabric. This configuration has the advantage that the pile fibers protruding from the plane of the support material are especially suitable for cleansing the pores and other irregularities of the skin. In turn, materials with a certain shape memory are especially preferred, which straighten up in the pore and capture the sebum located there. In particular, here as well the use of microfibers is preferred, since they are also suitable for the cleaning of very small irregularities thanks to their small diameter. Furthermore, when using the skin cleansing device of the invention the pile fibers produce a micromassaging effect, which has beneficial effect on the blood supply to the skin.

It is also advantageous to employ a pile fabric whose pile fibers only project on one side from the support material, because in this way especially large fiber densities can be achieved on this side, thus providing an especially large surface.

In an advantageous embodiment, the lipophilic fibers of the skin cleansing device of the invention contain filaments with a titer of 0.02 to 7 dtex and preferably between 0.05 and 5 dtex and especially preferably microfibers with microfilaments of a titer between 0.05 to less than 1 dtex. The small diameter of the filaments and especially the microfilaments helps provide an especially large active surface and thus promotes the uptake capability of the skin cleansing device, since the liquid taken up by the capillary action of the thin filaments is transported especially quickly into the interior of the textile body.

So that the pile fiber nap does not lose volume when acted upon by liquid, the microfilaments of the skin cleansing device of the invention are preferably crinkled, which likewise benefits their liquid uptake capability.

In order to form the largest possible active surface, furthermore, it is advantageous that the microfibers of the skin cleansing device of the invention have a twist count of 1360 dtex or less and preferably between 330 and 960 dtex. Besides increasing the active surface, the count of microfibers used here has the effect that the cleansing surface is not too rough and the skin is not excessively strained by the skin cleansing device of the invention. Having the microfiber nap with a density of microfibers between 30,000 and 300,000 fibers per cm² and especially preferably between 50 and 150,000 fibers per cm² especially fulfills the need for an especially large active surface.

As regards the configuring of an especially actively cleansing yet not too stressful skin cleansing surface, it is recommended to configure the microfibers from microfilaments which consist of one or more of the following materials: polyvinyl alcohol⁺ (PVA⁺), polypropylene (PP), rayon, polyester (PES), polyamide (PA) and/or polyacrylonitrile (PAN). These fibers have excellent liquid uptake capabilities, which benefits the absorption capability of the skin cleansing device. On the other hand, microfibers made from these materials are themselves very durable, yet do not excessively strain the skin surface being cleansed.

A convenient configuration of the skin cleansing device of the invention contains at least some brush fibers of high rigidity. The brush fibers produce a peeling effect when using the skin cleansing device of the invention, which helps loosen dead skin flakes, so that the pores are not clogged and the sebum can flow away unhindered.

In order to achieve a good peeling action, it is advantageous that the brush fibers have a twist count of 167 dtex or more, preferably between 220 and 1500 dtex. The use of brush fibers which contain polyester (PES) and/or polyvinyl chloride (PVC) and/or polycarbonate (PC) and/or polyamide (PA) and/or coarse natural fibers likewise fulfills this purpose.

The use of brush fibers made from multifilament yarn incorporates the brush fibers very well into the overall pile fabric, and furthermore the fine microfilaments of the multifilament yarn help further increase the active cleansing surface of the skin cleansing device. The brush fibers preferably project like barbs from the plane of the support material or curve up out from it and return back into it.

The use of crinkled brush fibers is also advantageous in respect of the voluminosity of the pile fabric and a good peeling effect.

For the combination of good oil absorbing capability and good mechanical peeling action on the same surface of the skin cleansing device of the invention, it is recommended to use a microfiber facing of between 80,000 and 120,000 fibers per cm², which is interspersed with brush fibers in a density of 50 to 1000 and preferably 300 to 500 fibers per cm².

The configuring of the skin cleansing device of the invention with brush fibers which project beyond the facing of microfibers is advisable when an especially good peeling effect is desired. When using crinkled microfibers and/or brush fibers, this can be achieved, for example, by having the brush fibers less crinkled than the microfibers or by using brush fibers and microfibers of different length.

The skin cleansing device of the invention is preferably fashioned as a glove, pad, cloth, or washcloth. The wash glove can be a glove having the entire hand surface or it can also be smaller in configuration. Thus, the configuration as a glove which only has the region from the index to the little finger and which the leaves the thumb free is likewise advantageous, in order to specifically clean small defined areas such as the area around the eyes.

The textile surface components of the skin cleansing device of the invention are preferably joined together by one or more lap seams from the outside. This technique is suitable because it enables a joining together of the subsequent user side in a technically economical manner and is hardly noticeable when using the skin cleansing device on the skin. When using pile fabric and configuring as a pad, two-sided washcloths, or glove, the individual surface components are joined together with the pile fibers facing outward and preferably sewn together by lap seam on the outside (leaving an opening to introduce the hand or several fingers when configured as a washing glove).

For cleaning of make-up residue etc. from the sensitive areas of the eyes, the use of a skin cleansing device according to the invention which is configured as a pad or a small washcloth leaving the thumb free is especially suitable. These devices preferably have a microfiber density of at least 20,000 per cm² and especially 100,000 per cm², in order to properly remove the heavy impurities. It is not advantageous to incorporate brush fibers in this case, since these would irritate the sensitive eye region too much.

Furthermore, it is especially convenient to configure the skin cleansing device of the invention as a glove or cloth which is only outfitted in places, preferably on one side, with brush fibers in a density between 300 and 500 per cm², while the other side has no brush fibers. In an especially advantageous configuration of the cloth or glove according to the invention, two plies of a one-sided pile fabric are joined together with the pile threads facing outward, one of the plies containing lipophilic microfibers with a density of 20,000 to 300,000 per cm² and being outfitted with brush fibers in a density of 50 to 500 per cm^{2.} The other ply preferably contains brush fibers in lesser density or even no brush fibers. This configuration allows the user to independently apply and individually dispense the peeling and cleansing functions according to the needs of his skin.

Thanks to its good oil absorbing capacity and peeling properties, the skin cleansing device of the invention is excellently suited to the method of cleansing of oily skin.

The properties of the skin, especially the facial skin, however, are subject to constant change due to seasonal temperature fluctuations, skin aging processes or hormonal fluctuations. Furthermore, the different zones of the face often have a different oil content. In order to meet the corresponding needs of the skin, the skin cleansing device of the invention in one embodiment can contain at least one area for the cleansing of dry or normal skin. The area incorporated in this configuration has properties which satisfy the needs of dry, sensitive skin in terms of oil absorption and mechanical abrasion. This area is preferably formed by a textile sheet structure, which has a smaller density of fibers and especially microfibers as compared to the skin cleansing device for oily skin, which like the microfilaments of which they are formed also have a larger diameter than the cleansing device for oily skin. Furthermore, the area has no brush fibers, but instead can contain fibers and particularly microfibers which are lipophobic and thus ideally suited to the needs of dry skin.

In this configuration, the skin cleansing device of the invention is especially suitable for the cleansing of mixed-type skin or normal skin. In any case, it is also possible to use a combination of a skin cleansing device for oily or mixed-type skin with a skin cleansing device for dry or normal skin according to the invention.

The invention shall be explained more closely hereafter by means of examples:

### EXAMPLE 1

In one example, the skin cleansing device is configured as a washing glove, consisting of pile fabric. One side of the washing glove is configured as the washing active side and it contains a pile fabric with a microfiber density of 100,000 fibers per cm² in a twist count of 600 dtex. The microfibers contain microfilaments of polyester (PES), which are crinkled and have a titer of 0.5 dtex. The special count of the microfibers used and of the microfilaments which form them, as well as the material used to produce the microfilaments, endow the washing active side of the skin cleansing cloth with an especially good oil absorbing capacity.

The other side of the skin cleansing washcloth contains a pile fabric with a facing of brush fibers in high density. The brush fibers have a twist count of 200 dtex and consist of polyamide (PA), which endow them with good stiffness and shape memory. The brush fibers are embedded in a nap of microfibers in a density of 500 per cm², which are more crinkled than the brush fibers themselves, so that the brush fibers project above the nap of microfibers, producing an especially good peeling effect.

The use of such a washcloth allows the user to individually adjust the cleansing activity on the one hand and the peeling activity on the other.

### EXAMPLE 2

In this example, the skin cleansing device is likewise configured as a washing glove, whose one side represents the peeling side. The other side of the skin cleansing glove is configured as the washing active side, containing two fields distinguished by different colors. One field consists of pile fabric with good oil absorbing capacity and a facing of microfibers with a twist count of 500 dtex, made of polypropylene microfilaments with a titer of 0.03 dtex, being arranged in a density of 200,000 microfibers per cm². The different-colored area of the washing active side of the washing glove consists of pile fabric which is adapted to the needs of dry skin. It contains microfibers in a twist count of 700 dtex with a density of 70,000 microfibers per cm². 30% of the microfibers consist of polyacrylonitrile microfilaments, which have an oil-repelling treatment of Teflon. The remaining 70% of the microfibers consist of rayon microfilaments in a titer of 0.3 dtex and have a twist count of 330 dtex.

Thanks to the cleansing areas outfitted with different cleansing properties, the skin cleansing glove enables optimal cleansing of mixed-type skin or skin whose properties range from oily to dry, depending on hormone levels. The color marking of the different cleansing areas provides the user with simple information so that he can adjust the use of the skin cleansing washcloth easily to his individual needs.

### EXAMPLE 3

In yet another example, the skin cleansing device is configured as a pad, which consists of two plies of round-cut one-sided pile fabric. The plies are joined together “back to back”, so that the pile fibers project outward on both sides of the pad. The two plies are sewn together by means of a lap seam on the outside, which is technically easy to perform, unnoticeable, and does not irritate the skin when cleansing with the pad. This is especially important, since the skin around the eyes is very sensitive. The two plies of pile fabric have a fiber density of 20,000 fibers cm² and contain no brush fibers. The fibers are configured as microfibers of a 500 dtex polypropylene microfilament of a titer of 0.03 dtex.

This configuration is especially well suited to cleansing the sensitive area of the eyes of make-up residue, etc., because it provides an especially large lipophilic cleansing surface by virtue of the dense facing with microfibers of small titer and small microfilament diameter, having a good ability to take up impurities, yet not irritating the skin.

1. Skin cleansing device made of textile structure, characterized in that it has at least in part a facing of lipophilic fibers.

2. Skin cleansing device per claim 1, characterized in that the lipophilic fibers are at least partly configured as microfibers.

3. Skin cleansing device according to one of claims 1 or 2, characterized in that it is outfitted at least in part with a fiber density of 30,000 per cm² or more.

4. Skin cleansing device according to one of the preceding claims, characterized in that the textile structure is configured at least partly as a pile fabric.

5. Skin cleansing device per claim 4, characterized in that the pile threads of the pile fabric project from the support material on only one side.

6. Skin cleansing device per claim 4 or 5, characterized in that the pile fabric is at least partly outfitted with a facing of lipophilic microfibers in a density of 30,000 per cm² or more.

7. Skin cleansing device according to one of claims 1 to 6, characterized in that it contains lipophilic fibers with filaments of a titer of 0.02 to 7 dtex, preferably between 0.05 and 5 dtex and especially preferably from 0.05 to under 1 dtex.

8. Skin cleansing device made from a textile structure according to one of claims 2 to 7, characterized in that the microfibers are crinkled.

9. Skin cleansing device made from a textile structure according to one of claims 2 to 8, characterized in that the microfibers have a twist count of 1360 or less, preferably between 330 and 960 dtex.

10. Skin cleansing device made from a textile structure according to one of claims 2 to 9, characterized in that the microfibers are at least partially present in a density of between 30,000 and 300,000 per cm², preferably between 50,000 and 150,000 per cm².

11. Skin cleansing device according to one of claims 2 to 10, characterized in that the microfibers contain microfilaments made of one or more of the following materials: polypropylene (PP), rayon, polyacrylonitrile (PAN), polyvinyl alcohol⁺ (PVA⁺), polyester (PES), polyamide (PA).

12. Skin cleansing device according to one of the preceding claims, characterized in that it contains at least partially brush fibers of high rigidity.

13. Skin cleansing device per claim 12, characterized in that the brush fibers have a twist count of 167 dtex or more, preferably between 220 and 1500 dtex.

14. Skin cleansing device [according to] one of claims 12 or 13, characterized in that the brush fibers contain polyester (PES) and/or polyvinyl chloride (PVC) and/or polycarbonate (PC) and/or polyamide and/or coarse natural fibers.

15. Skin cleansing device according to one of claims 12 to 14, characterized in that the brush fibers consist of multifilament yarn.

16. Skin cleansing device according to one of claims 12 to 15, characterized in that the brush fibers project from the plane of the support material as barbs or curve up from it and go back into it.

17. Skin cleansing device according to one of claims 12 to 16, characterized in that the brush fibers are crinkled.

18. Skin cleansing device according to one of claims 12 to 17, characterized in that it has a microfiber facing of between 80,000 and 120,000 per cm², which is interspersed with brush fibers of a density from 50 to 1000 and preferably between 300 and 500 per cm².

19. Skin cleansing device according to one of claims 12 to 18, characterized in that the brush fibers project beyond the facing of microfibers.

20. Skin cleansing device according to one of the preceding claims, characterized in that it is configured as a glove, pad, cloth or washcloth.

21. Skin cleansing device per claim 20, characterized in that it is joined together by lap seams.

22. Skin cleansing pad or glove leaving the thumb free per claim 20 or 21, characterized in that it consists of two plies of single-sided pile fabric, which is joined together with the pile threads facing outward.

23. Skin cleansing pad or glove leaving the thumb free according to one of claims 20 to 22, characterized in that it has a microfiber facing with a density of at least 20,000 per cm², preferably at least 100,000 per cm².

24. Skin cleansing glove or washcloth according to one of claims 20 or 21, characterized in that it
a) consists of two plies of one-sided pile fabric, which are joined together with the pile threads facing outward, wherein
b) one of the plies contains lipophilic microfibers with a density of 20,000 to 300,000 per cm² and is outfitted with brush fibers in a density between 50 and 500 per cm² and
c) the other ply contains brush fibers in lesser density or no brush fibers.

25. Skin cleansing device according to one of the preceding claims, characterized in that it has at least one area for cleansing of dry or normal skin.

26. Method for cleansing of skin, preferably oily skin and mixed-type skin, characterized in that a skin cleansing device according to one of the preceding claims is used.

27. Method for cleansing of skin per claim 26, characterized in that in addition a skin cleansing device for cleansing of dry or normal skin is used.
